(19) United States
(12) Patent Application Publication
(10) Pub. No.: US 2026/0319607 A1
(43) Pub. Date: Oct. 15, 2026

(54) DISPLAY DEVICE AND DISPLAY METHOD

(71) Applicant: KEBA Industrial Automation GmbH, Linz (AT)

(72) Inventor: Bernhard LEHNER, Hirschbach (AT)

(73) Assignee: KEBA Industrial Automation GmbH, Linz (AT)

(21) Appl. No.: 19/476,282

(22) PCT Filed: Apr. 18, 2024
(86) PCT No.: PCT/AT2024/060157

§ 371 Date: Oct. 17, 2025

(30) Foreign Application Priority Data
Apr. 19, 2023 (DE) 10 2023 109 914.0

(51) Int. Cl. G06F 3/041; G05B 9/02; G06F 3/0488; G06F 3/14; G06V 40/12; G06V 40/13

(52) U.S. Cl. CPC G06F 3/0416; G05B 9/02; G06F 3/0488; G06F 3/14; G06V 40/1318; G06V 40/1365; G06V 2201/06

(57) ABSTRACT

A display device has a display unit which is configured at least to display one or more buttons, a transparent and touch-sensitive layer which is arranged on the display unit and which is configured to detect actuations of the display device and their positions, at least one detection device which is configured to detect the buttons of the display unit and actuations of the display device and their positions, and a computing device which is configured to check whether the buttons of the display unit detected by the at least one detection device correspond to the buttons to be displayed by the display unit, and/or whether the actuations and/or positions detected by the layer and the at least one detection device correspond to each other and to the displayed buttons. Also, a method displays on the display device and a computer program product executes the method.

### CROSS REFERENCE TO RELATED APPLICATIONS

This application is the National Stage of PCT/AT2024/060157 filed on Apr. 18, 2024, which claims priority under 35 U.S.C. § 119 of German Application No. 10 2023 109 914.0 filed on Apr. 19, 2023, the disclosure of which is incorporated by reference. The international application under PCT article 21(2) was not published in English.

### BACKGROUND OF THE INVENTION

### 1. Field of the Invention

The invention relates to a display device and a method for displaying.

### 2. Description of the Related Art

In the state of the art, display devices are already frequently realized using touch screens, in which a touch-sensitive layer detects the touch of a screen by a finger or another part of the body, or also by a separate input device.

When operating machines and devices, safety is desired or even prescribed in various applications in order to avert danger to persons, i.e. to prevent injuries. In order to ensure the safe operation of machines and devices, unintentional contact must be prevented from triggering unwanted actions or processes. For safety reasons, it is also essential to implement the error-free realization of an operator's actual will. To do this, it must be ensured that the person knows which function is linked to pressing a button. If displayed control elements have different functions depending on the situation, or if the displayed control elements and the functions they perform do not match due to a faulty display, a hazard may arise.

Touch user interfaces are particularly suitable for a variable display, i.e. different operating elements with different functions can be displayed at one and the same point in the input area depending on the operating status. For safety reasons, it is therefore necessary to recognize a faulty function of the hardware and software components required for the display or to check the plausibility of their function. If a fault occurs, it must either be technically detectable or recognizable to the operator before a hazard occurs. In some applications, it is also desirable that certain actions can only be triggered by authorized persons.

A safe method for operating an industrial robot is shown in EP 2 834 050. A virtual control element representing a function or operating mode of the industrial robot is shown on the touch display by means of a graphical user interface with a touch display. After selecting the control element, another control element is shown in a constantly changing position on the touch display and the function or operating mode is only activated after this other control element is actuated. This means that a function is only executed after the additional actuation of a separately displayed control element at a specific but constantly changing position.

The disadvantage of this is that a two-stage method is used, i.e. first actuating the desired function elements and then confirming by actuating a second button that is displayed separately and always in a different position. With conventional touch screen systems, a lack of safety is not acceptable in the context of industrial machine operation if, for example, an accidental touch cannot be distinguished from an intentional touch and an operator cannot recognize without error what an intended operation will cause. This is a particular problem with functional elements that change over time or depending on the operating status. It must also be possible to check that the information displayed for the functions is also displayed correctly. A defective display controller could, for example, cause the display to freeze and a certain previously assigned function to be signaled for an actuating element, although the evaluation of the input sensor for the display position superimposed on the display leads to the triggering of a control command that has already been reassigned.

US 2012/019485 A1 describes an information processing device that can be influenced by operator gestures. The technical solution proposed in this document achieves that multiple operators can perform gesture operations in three-dimensional space, and the three-dimensional spatial gesture of each operator is precisely associated with the target object of the three-dimensional spatial gesture. For this purpose, a projector projects at least one selection target object onto the top of a table. When a pointer operated by an operator touches the upper surface of the table, a device for recognizing two-dimensional coordinates recognizes the contact position and determines which object was designated by the operator. At this stage, among the pointers recognized by a three-dimensional coordinate recognition device, the pointer whose position is closest to the contact position is determined, and the pointer determined to be closest is set as the tracking target. The tracking target pointer is then tracked by the three-dimensional coordinate recognition device to determine the operator's gesture pattern.

US 2016/314727 A1 describes an interaction system with which a user can interact with a data processing device. A depth camera is used to recognize a desktop edge by increasing the captured distance along the axis from the depth camera to the desktop edge and then the desktop edge is used as the origin for a coordinate system that defines a projection area for displaying a user interface. By monitoring end-user input and projected output relative to the desktop edge, a user's interactions via the projected user interface can be coordinated if the camera or projector moves relative to the desktop surface.

Further display and interaction devices for technical systems are known from US 2018/144673 A1, US 2015/091811 A1, U.S. Pat. No. 10,809,882 B1, CN 114 780 321 A, or US 2016/063230 A1.

### SUMMARY OF THE INVENTION

The object of the present invention is to overcome the disadvantages of the prior art and, among other things, to improve safety when operating machines and devices using touch screens.

A display device, a method for displaying, a use of the display device and a computer program product are provided.

The object of the invention is solved by the subjects of the independent claims. Further advantageous advancements can be found in the dependent claims.

In the following, the embodiments of the invention are described, wherein it is pointed out that the embodiments can generally concern both the device and the alternative forms of implementation (method, use, computer program product, etc.).

In a first aspect, according to a first embodiment, a display device is provided, with a display means, a transparent and touch-sensitive layer, at least one detection device and a computing device.

The display means is at least configured to display one or more buttons. The transparent and touch-sensitive layer, which is arranged on the display means, is configured to detect actuations of the display device and its positions. The at least one detection device is configured to detect the buttons of the display means and actuations of the display device and their positions. The computing device is configured to check whether the buttons of the display means detected by the at least one detection device correspond to the buttons to be displayed by the display means, and
whether the actuations and/or positions detected by the layer and the at least one detection device correspond to each other and to the displayed buttons.

According to a further aspect of the invention, a method for displaying is provided. The method for displaying on a display device comprises
displaying one or more buttons by a display means. Next, a transparent and touch-sensitive layer arranged on the display means detects actuations on the display device and their positions, and at least one detection device detects both the buttons of the display means and the actuations of the display device and their positions. Finally, a computing device checks whether the buttons of the display means detected by the at least one detection device correspond to the buttons to be displayed by the display means, and
whether the actuations detected by the touch-sensitive layer and the at least one detection device correspond to each other and to the buttons.

The advantage here is that a double plausibility check, i.e. verification, can take place. On the one hand, the system checks whether the detected buttons actually correspond to the buttons to be displayed, which ensures that an operator is correctly informed about the function currently linked to an actuation. Secondly, it is checked whether the actuations and positions detected by two channels (the touch-sensitive layer and the detection device) correspond to each other, so that unwanted triggering, for example due to static discharge, contamination or condensation on the surface, is avoided, especially since the layer and the detection device use different technologies for detecting an actuation, which is also referred to as diversity, and thus a single fault influence does not affect both systems simultaneously and in the same way. This enables the display device or its computing device to determine whether the display is correct and, if an error is detected, to prevent the triggering of an incorrect function and avoid false triggering.

The following embodiments may relate to any of the aforementioned aspects of the invention. The computing device is further configured to send information or control signals depending on the result of checking.

This ensures safe operation of the machine or device to be operated. In particular, a potentially dangerous function is only triggered if the display of the button actually corresponds to the function assigned by the control system and an operator can be informed of the presence of a device error in the display device and the faulty display device can be put out of operation. The control signals can also be control commands.

In further embodiments, the display means may be designed as a film, such as a liquid crystal display or light-emitting diode film. The transparent and touch-sensitive layer may also be designed as a film, for example as a touch screen film. The detection devices may be a camera or a light field film, for example.

The advantages of these individual embodiments are described in more detail below.

In a further embodiment, one of the at least one detection device is a fingerprint sensor, which is arranged either directly below the display means, between the touch-sensitive layer and the display means or above the touch-sensitive layer. It is configured to detect fingerprints.

By detecting fingerprints, for example, operation by hand can be ensured and triggering by elbows or other parts of the body can be avoided.

In a further embodiment, the computing device is furthermore configured to check whether the fingerprints captured by the fingerprint sensor correspond to fingerprints stored in a data memory, whereby the authorization of an operating person can be checked.

By comparing fingerprints with stored data, biometrics can be used to restrict access to the control system or display. The access restriction may affect the control system as a whole, i.e. activation of the control panel, or an individual operation of a functional element. Checking is advantageously carried out for each individual operating action, so that, for example, two people can very well carry out alternating operating actions via the display device at the same time, although only one of the people can also trigger potentially dangerous functions and these are prevented for the other person.

In a further embodiment, the at least one detection device and the touch-sensitive layer are further configured to detect gestures during actuation, and the computing device is further configured to check whether the gestures detected by the touch-sensitive layer and the at least one detection device correspond to each other and to gestures stored in a data memory.

It is advantageous that the operating options are extended and the buttons can be actuated in more than one way to trigger different functions or actions.

In a further embodiment, the display means comprises two or more display parts, wherein each display part is configured to display a part of each button. In a first implementation, the display parts are arranged one above the other and at least one display part is semi-transparent. The buttons are created by superimposing the partial displays. The partial displays can be made deferred in place and time. In a second implementation, the display parts are arranged next to each other and each button extends to each display part.

The display via two or more partial displays enables an operator to recognize beyond doubt if one of the partial displays has failed, i.e. that at least one of the display parts is defective and the use of the terminal is therefore no longer permitted due to a possible hazard, because the displays of the partial displays do not correspond. For example, the safety of a system can only be guaranteed if it is ensured that the display is correct. This is the only way the user can be sure which effect actuating a button has. The division of a button into two or more superimposed display parts makes it recognizable to the user that at least one of the displays is defective if the representations do not correspond, and therefore the use of the system is no longer permitted due to a possible hazard. Technically, this is a dual-circuit signaling up to the user's eye.

In a further embodiment, the buttons or their surrounding areas are displayed with one or more of the following properties:
changing the display position after a predetermined time, showing a continuous movement over the display means, visible flashing, flashing in such a way that the flashing is not visible but can be detected by the detection device, showing a dynamic change in brightness and/or color, and/or
showing patterns in a dynamic change of brightness and/or color.

With these properties of the display, an operator can recognize that the display is operating outside normal working parameters and that there may be an error, which would make operation unsafe and therefore not permitted. However, the properties may also provide additional information and enable or facilitate additional functions.

In a further embodiment, the computing device is configured to perform the checks as described above for two or more buttons simultaneously.

This allows the display device to provide several buttons for different potentially hazardous functions simultaneously and without preselection for a user, for example for two directions of movement of a machine axis or also for several machine axes. Simultaneous checking for several buttons is also advantageous for two-handed operation, where operation by both hands of one person is prescribed in order to increase safety.

In a further embodiment, the computing device is furthermore configured to take into account an actuation of a button detected by the at least one detection device only when a predefined period of time has elapsed between the start of the display of the button and its actuation.

This can prevent unintentional actuation in such a way that the display changes shortly before the display device is touched and then a button is actuated that has just appeared. This applies both to the dynamic options for changing the display as described above, but also to the options for displaying new buttons on previously empty areas.

In a further embodiment, the display means displays the buttons differently during the predefined period of time than after the predefined period of time has elapsed.

It is advantageous that an operator can see when a button can be used, which can prevent invalid actuations or surprisingly delayed function executions.

A second aspect of the invention relates to the use of a display device described above as fail-safe display means in control systems of potentially hazardous technical systems, such as industrial plants, machines or motor vehicles.

According to a further aspect of the invention, a computer program product is described which is loadable directly into a memory of a programmable control apparatus of a display device, with program code means for executing all steps of a method described herein when the program product is executed on the control apparatus.

The embodiments show possible embodiment variants, wherein the invention is not limited to the specifically shown embodiment variants thereof, but rather combinations of the individual embodiment variants with one another are also possible. In particular, the features of the device may also be implemented in a method and vice versa.

### BRIEF DESCRIPTION OF THE DRAWINGS

For a better understanding of the invention, it is explained in more detail with the aid of the following figures. The figures show a simplified, schematic representation as follows:

FIG. 1 a display device according to exemplary embodiments,

FIG. 2 an exemplary embodiment with partial displays, and

FIG. 3 a schematic flow chart according to exemplary embodiments.

### DETAILED DESCRIPTION OF PREFERRED EMBODIMENTS

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

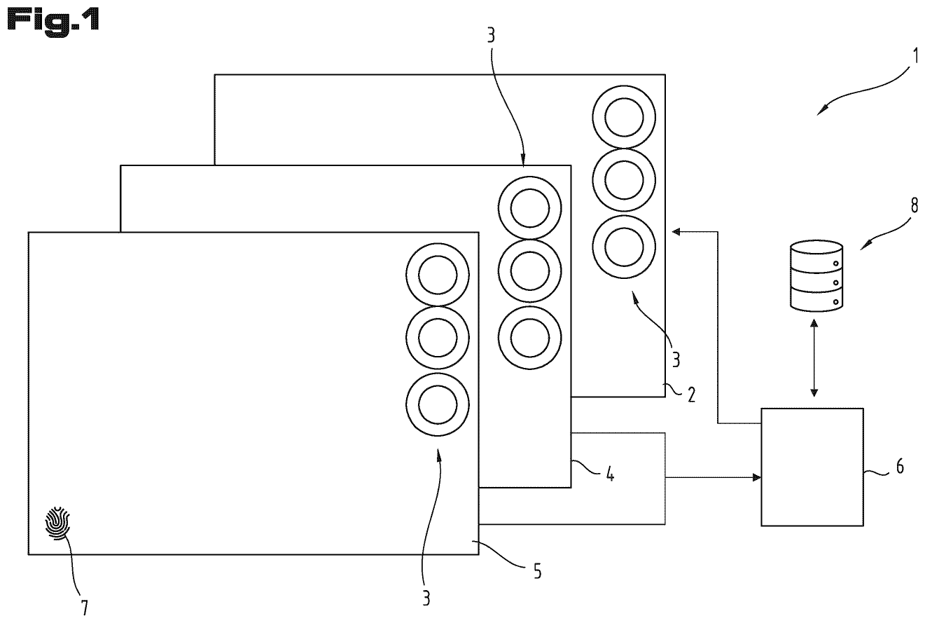

FIG. 1 shows an exemplary structure of a display device 1 in schematic representation. This comprises a display means 2, a transparent and touch-sensitive layer 4, a detection device 5 and a computing device 6. In FIG. 1, the display means 2 shows three buttons 3 as an example, but more or fewer buttons 3 may also be displayed. The buttons 3 are also shown on the transparent and touch-sensitive layer 4 and the detection device 5, as these show through to the top.

It should be noted that FIG. 1 is only a schematic representation of an implementation.

The display means 2 shows at least one or more buttons 3.

The transparent and touch-sensitive layer 4, which is arranged on the display means 2, detects actuations of the display device 1 and their positions.

The at least one detection device 5 optically detects the buttons 3 of the display means 1 as well as actuations of the display device 1 and their positions. The detection device 5 detects at least characteristic features of the display of the buttons 3. The detection device 5 may also cover only a part of the display device 1, for example in the case of an optical fingerprint sensor 7 or in the case of a detection device that only detects a button 3. The position detection may be achieved by knowing the position of the detection device 5 and using it accordingly.

The computing device 6 checks whether the buttons 3 of the display means 2 detected by the at least one detection device 5 correspond to the buttons 3 to be displayed by the display means 2.

The computing device 6 alternatively or additionally checks whether the actuations and/or positions detected by the touch-sensitive layer 4 and the at least one detection device 5 correspond to each other and to the displayed buttons 3.

For example, the display means 2 may be configured as a film. This may be a liquid crystal display or light-emitting diode film. However, it is also conceivable that the display means 2 is another type of display, such as a monitor, an OLED or LCD display or similar. The display means 2 shows buttons 3. As a button 3, the respective display is linked to an action or function in terms of control, so that, for example, when a device is controlled by the display device 1, an action for the device is to be started by pressing a button 3. As described later, several functions or actions may also be alternately assigned to a button 3, which on the one hand may be context-dependent, i.e. depending on the operating and control situation, different actions may be triggered by a button 3, and on the other hand several coupled actions may also be assigned simultaneously and then triggered simultaneously with one actuation.

The display means 2 is at least configured to display the buttons 3, i.e. other elements may also be displayed in addition to the buttons 3, i.e. the interactive elements of the display. These may include a photo or video signal which, for example, depicts processes inside the device to be controlled. Measured values, e.g. the device to be controlled or environmental conditions such as temperature and humidity, may also be displayed. Other, non-safe buttons may also be provided that are used for non-critical functions, such as switching the display, changing parameters or similar. Information relating to communication may also be displayed, such as an incoming call or a text message addressed to the user, such as an e-mail or other text message.

The transparent and touch-sensitive layer 4 may also be in the form of a film. It is arranged on the display means 2 and must therefore be translucent. For example, it may be designed as a capacitive or resistive touch screen film.

The transparent and touch-sensitive layer 4, which is arranged on the display means 2, detects actuations of the display device 1 and their positions. This means that the layer 4 can determine that the display device 1 is being actuated and also at which position of the display device 1 this actuation takes place.

An alternative embodiment may provide for the display means 2 and the layer 4 to be designed as an integrated component. This would be, for example, a film that can display a button and at the same time detect actuations and positions, which is commonly known as a touch screen and is widely used.

The detection devices 5 may be designed in different ways. One example is a light field film, which can be arranged on or under the transparent and touch-sensitive layer 4. In FIG. 1, it is arranged on the transparent and touch-sensitive layer 4 and must therefore also be transparent or translucent. Even if it is arranged under the transparent and touch-sensitive layer 4, but on the display means 2, it must be transparent or translucent. A detection device 5 in the form of a film or fingerprint camera could also be arranged under the display means 2, in which case it would not be necessary for the detection device 5 to be transparent or translucent.

The detection devices 5 may also be designed as other optical systems, e.g. a camera, and accommodate the display means 2 and the layer 4. The camera or cameras can record the display means 2 and the layer 4 from different positions, for example from below or from above, where the user can also be detected.

A detection device 5 detects the buttons 3 of the display device 1 and actuations of the display device 1 and their positions. In other words, just like the layer 4, a detection device 5 can determine that the display device 1 is actuated and also at which position of the display device 1 this actuation takes place. In addition, however, a detection device 5 can also detect the buttons 3 displayed by the display means 2 and their positions.

In the display device 1, one or more of the detection devices 5 may be designed as a fingerprint sensor 7. Depending on the design, these can be arranged directly under the display means 2, between the layer 4 and the display means 2 or above the layer 4. A fingerprint sensor 7 is configured to detect fingerprints.

FIG. 1 shows an exemplary fingerprint sensor 7, wherein the position shown in FIG. 1 represents an arrangement on the detection device.

For example, two fingerprint sensors 7 that are positioned far enough apart may be used to require a security-relevant two-handed operation. For example, the function that requires the two-handed operation may be stored as an action behind one of the two fingerprint sensors 7, but can only be triggered if the second fingerprint sensor 7 also successfully reads a fingerprint.

A fingerprint read by a fingerprint sensor 7 may also be compared with fingerprints stored in a data memory 8 in order to realize a restriction for some functions. This means, for example, that only an authorized person could shut down or switch off a machine or restart it after a fault. For safety-critical operations, it can thus be ensured that only a restricted group of people can perform a certain action, for example particularly reliable, specially trained or specially tested persons whose fingerprints have been technically registered beforehand. Such operating actions are prevented for other persons, even if they are in the vicinity of an operating terminal at the same time as authorized persons.

A plurality of detection devices 5 may also be used in the display device 1, which may also comprise different types, e.g. a light field film, three cameras and two fingerprint sensors 7.

Such fingerprint sensors 7 may, for example, be designed as low-resolution cameras integrated into the display. Comparable sensors are also used in mobile phones.

One or more of the detection devices 5 and/or the layer 4 may also be capable of detecting gestures during actuation. The computing device 6 can then check whether the detected gestures correspond to each other, which increases security, and also check whether the detected gestures correspond to gestures stored in a data memory 8.

In the latter case, a function linked to the gesture, which may differ from the regular function of the button 3, may be triggered. For example, a button 3 cannot normally trigger a function in order to be particularly protected against unintentional actuation, but actuation with a circular or pulling gesture triggers the button 3 and leads, for example, to the unlocking of the other buttons 3. Alternatively, other functions may also be assigned to the simple actuation and the gesture actuations, for example a movement of a machine axis may be effected in one direction or the opposite direction depending on the direction of movement of the finger. The advantage here is that a single detection device 5, for example a fingerprint sensor 7, can be used to make several functions available at a single point using a button 3, for example by swiping.

The computing device 6 may be responsible for transferring the buttons 3 and other information to be displayed to the display means 2. However, this may also be done by another computing device. The computing device 6 may send information or control signals depending on the result of checking. This may have a direct or indirect effect on the display on the display means 2. The information or control signals sent may, for example, inform the device to be controlled by the display device 1 of the functions and actions actuated, thereby controlling the device. The control signals can also be control commands.

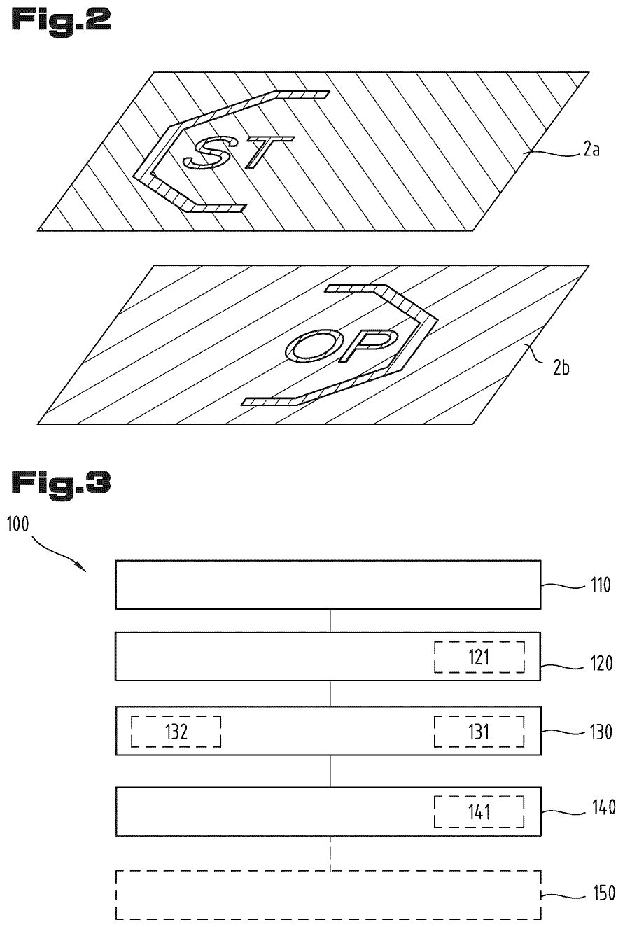

FIG. 2 shows that the display means 2 may consist of two or more display parts 2a, 2b. FIG. 2 shows an embodiment in which the display means 2 consists of two display parts 2a, 2b. Each of the display parts 2a, 2b shows a part of a button 3. The display parts 2a, 2b are shown in FIG. 2 arranged one above the other. At least one display part 2a, or more precisely at least all but one, namely the lowest one, is semi-transparent, translucent or transparent, which is indicated in FIG. 2 by the hatching of the plane shown above. The buttons 3 are created by superimposing the partial displays on the display parts 2a, 2b. If one of the display parts 2a, 2b fails, an operator can recognize this without any doubt and potentially dangerous use can be avoided.

The display variant described above describes the display of the partial displays deferred in place.

The partial displays may also be deferred in time so that the display parts alternate. If one of the display parts then fails, a display interruption occurs, indicating a potentially dangerous situation, allowing the operator to avoid actuation.

As an alternative to the variant described above, in which the display parts are arranged one below the other, a variant is also conceivable in which the display parts 2a, 2b are arranged next to each other and each button 3 extends to each display part 2a, 2b. This may be realized, for example, by implementing a pixel grid with different control units.

The display of buttons 3 can be further improved in various ways.

The surrounding areas are the areas that are displayed in the direct vicinity of a button. These may display content that can be assigned to the button 3 or its function or action, or also provide information on the alternative functions or actions that can be performed using gestures or alternative actuation methods via the button 3, such as double or multiple presses, press and hold, press harder, press with an input device such as a stylus or glove, etc.

One or more buttons 3 may change the display position after a predetermined time. On the one hand, this can prevent damage to the display means 2, e.g. increased wear at the point, and on the other hand, it can also counteract a trained behavior pattern of an operator, since the buttons 3 may be located at new positions and the currently desired button 3 must therefore be actively searched for and consciously actuated.

One or more buttons 3 may have a continuous movement across the display means 2. This means that an operator must pay full attention to the display device to ensure that they cannot overlook current information or warnings. Above all, however, an operator can recognize a frozen and therefore invalid screen display due to a technical defect.

One or more buttons 3 or surrounding areas may flash visibly, wherein the flashing indicates that the display is functioning correctly. If the display does not flash, this would mean that there is a fault in the display unit. Alternatively, additional information may also be output via the flashing. This may happen via the fact that a button flashes, but also via a predetermined rhythm or a predetermined pattern, a predetermined frequency or speed, wherein the pattern and speed may also change. For example, a pattern may indicate a status, such as “ready”, “busy”, “error”, and a speed may indicate a time that is still available for a function, i.e. the faster a button 3 flashes, the shorter it is still available.

The flashing may also be designed in such a way that the flashing is not visible but can be detected by the detection device 5. An example of this is a very high frequency flashing, or a long display phase combined with a short fade-out phase. This type of flashing could be designed in such a way that an operator would not notice it, but a suitably configured camera would be able to detect the flashing. The actively controlled flashing may signal to the detection device 5 that the display control is still active and that there is no system error, i.e. failure of the display control.

The buttons 3 or the surrounding areas may also be provided with a dynamic change in brightness and/or color, in each case with or without a pattern. These may be displayed for the operator or, as described above, in such a way that only an appropriately configured detection device 5, but not the operator, can detect them.

By changing the brightness or colors, it is also possible to display error-free operation or additional information as described above.

The computing device 6 may also perform the checks described above for two or more buttons 3 simultaneously. This is particularly useful if the display device is used for several control panels that are to be operated by several people. Simultaneous checking for several buttons 3 is also advantageous for two-handed operation, where operation by both hands of one person is prescribed in order to increase safety.

To check whether the actuations detected by the layer 4 and the detection devices 5 correspond to each other, the computing device 6 may only take into account a detected actuation of a button 3 if a predefined period of time has elapsed between the start of the display of the button 3 and its actuation.

This can prevent unintentional actuation in such a way that the display changes shortly before the display device 1 is touched and then a button 3 is actuated that has just appeared. This applies both to the dynamic options for changing the display as described above, but also to the options for displaying new buttons 3 on previously empty areas.

The display means 2 may display the buttons 3 differently during this time period, i.e. as long as the button 3 is not yet active, than after the period of time has elapsed, i.e. when the button 3 is active. This can be achieved using the options mentioned above, such as flashing, color, brightness, etc.

It is advantageous that an operator can see when a button 3 can be used, while at the same time its assigned function can be recognized in advance, which means that invalid actuations can be avoided.

FIG. 3 shows a schematic flow chart which is now used to describe the method 100. Optional features are shown as dashed lines. It should be pointed out once again that the features of the device already described are generally also applicable to the method, which is why all the details relating to the method are not described again.

First, in step 110, at least one or more buttons 3 are displayed by a display means 2. Then, in step 120, actuations of the display device 1 and their positions are detected by a transparent and touch-sensitive layer 4, which is arranged on the display means 2.

Simultaneously, but also before or after step 120, in step 130 at least one detection device 5 detects the buttons 3 of the display means 2 and actuations of the display device 1, as well as their positions.

When detecting the buttons in step 130, the representation of the buttons 3 or also certain characteristics, such as a frequency, of the representation can be detected.

In step 140, a computing device 6 checks whether the buttons 3 of the display means 2 detected by the at least one detection device 5 correspond to the buttons 3 to be displayed by the display means 2.

This determines whether the display means 2 is functioning correctly. In addition, the computing device 6 checks in step 140 whether the actuations detected by the layer 4 and the at least one detection device 5 correspond to each other and to the buttons 3. This means that an actuation is plausibility-checked via two channels, i.e. the layer 4 and the detection devices 5. If the actuation data of the layer 4 and the detection devices 5 correspond in terms of location and time, an actuation of the button 3 is detected more reliably than via just one channel.

Optionally, the computing device 6 may send information or control signals in step 150 depending on the result of checking 140. This may be used to control a device, for example, but may also contain the result of checking 140 and thus trigger an error message.

One of the detection devices may be or comprise a fingerprint sensor 7, in particular an optical fingerprint sensor. In this case, the step 130 may comprise a sub-step 131 in which fingerprints are detected. Alternatively, for example, in the presence of a plurality of detection devices 5, one of the detection devices 5, which is a fingerprint sensor 7, may perform the fingerprint detection as the only content of the step 130.

If fingerprints were captured in the step 130, the step 140 of the computing device 6 may comprise checking 141 whether the detected fingerprints correspond to fingerprints stored in a data memory 8. For safety-critical operations, it can thus be ensured that only a restricted group of people can perform a certain action, for example particularly reliable, specially trained or specially tested persons whose fingerprints have been technically registered beforehand. Such operating actions are prevented for other persons, even if they are in the vicinity of an operating terminal at the same time as authorized persons and cannot perform safety-critical operating actions on the operating terminal.

Biometrics may therefore be used for general access restriction or to restrict access to individual operating actions.

In addition, as an optional feature, both the layer 4 and the detection devices 5 may detect gestures during the actuation in a sub-step 121 or 131 in the step 120 or 130, respectively. The computing device 6 may then in turn check, as part of the step 140 as a sub-step 141, whether the detected gestures correspond to each other and correspond to gestures stored in a data memory 8.

The buttons may be displayed in the step 110 by two or more display parts 2a, 2b of the display means 2 in such a way that each display part 2a, 2b displays a part of each button 3 in such a way that the buttons 3 are created by superimposing the partial displays, wherein the partial displays can be made deferred in place and time.

Alternatively, the display parts 2a, 2b may display a part of each button 3 in such a way that each button 3 extends to each display part.

The display 110 of the buttons 3 may be further improved by the following features when displaying the buttons 3 or the surrounding areas: changing the display position after a predetermined time, showing a continuous movement over the display means, visible flashing, flashing in such a way that the flashing is not visible but can be detected by the detection device 5, showing a dynamic change in brightness and/or color, and/or showing patterns in a dynamic change of brightness and/or color.

In addition, the computing device may check two or more buttons 3 simultaneously in the step 140, wherein this may take place in parallel processes genuinely simultaneously or directly one after the other.

Checking in step 140 may also be designed such that an actuation of a button 3 is only taken into account if a predefined period of time has elapsed between the start of the display of the button 3 and its actuation. The button 3 may be displayed differently during the predefined period of time than after the predefined period of time has elapsed.

A further aspect is a computer program product comprising instructions which, when the program is executed by a computer, cause the computer to perform one of the methods described above.

A further aspect is a computer-readable medium on which the computer program product is stored.

A further aspect is the use of the display device 1 described above as fail-safe display means in control systems of potentially hazardous technical systems, such as industrial plants, machines or motor vehicles.

The exemplary embodiments show possible embodiment variants, wherein it should be noted at this point that the invention is not limited to the specifically illustrated embodiment variants thereof.

The scope of protection is determined by the claims. However, the description and the drawings should be consulted to interpret the claims.

Finally, as a matter of form, it should be noted that for ease of understanding of the structure, elements are partially not depicted to scale and/or are enlarged and/or are reduced in size.

### LIST OF REFERENCE SIGNS

1 display device
2 display means
2a, 2b display parts
3 buttons
4 transparent and touch-sensitive layer
5 detection device
6 computing device
7 fingerprint sensor
8 data memory
100 method for displaying
110 display of buttons
120 detecting actuations and positions
121 detecting gestures
130 detecting buttons and positions
131 detecting gestures
132 detecting fingerprints
140 checking the correctness and accordance of the positions
141 checking gestures
150 sending information or control signals

1. A display device (1) for a control system of potentially hazardous technical systems, such as industrial plants, machines or motor vehicles, the display device comprising:
a display means (2) which is configured at least to display one or more buttons (3),
a transparent and touch-sensitive layer (4) which is arranged on the display means (2) and which is configured to detect actuations of the display device (1) and their positions,
at least one detection device (5) which is configured to detect the buttons (3) of the display means (1) and actuations of the display device (1) and their positions,
and
a computing device (6) which is configured to check
whether the buttons (3) of the display means (2) detected by the at least one detection device (5) correspond to the buttons (3) to be displayed by the display means (2), and
whether the actuations and/or positions detected by the layer (4) and the at least one detection device (5) correspond to each other and to the displayed buttons (3), and
wherein the computing device (6) is further configured to send information or control signals depending on the result of checking, so that a safe sequence is achieved in a machine or device to be operated by actuation of the display device (1) by only triggering a potentially dangerous function, assigned by the control system to the button (3) if the display of the button (3) detected by the detection device (5) actually corresponds to the function assigned by the control system to the button (3).

2. (canceled)

3. The display device (1) according to claim 1, wherein the display means (2) is designed in the form of a film, in particular as a liquid crystal display or light-emitting diode film.

4. The display device (1) according to claim 1, wherein the transparent and touch-sensitive layer (4) is designed in the form of a film, in particular as a touch screen film.

5. The display device (1) according to claim 1, wherein one of the at least one detection device (5) is a light field film.

6. The display device (1) according to claim 1, wherein one of the at least one detection device (5) is a fingerprint sensor (7) which is arranged directly below the display means (2), between the layer (4) and the display means (2) or above the layer (4) and is configured to detect fingerprints.

7. (canceled)

8. The display device (1) according to claim 6, wherein the computing device (6) is furthermore configured to check whether the fingerprints detected by the fingerprint sensor (7) correspond to fingerprints stored in a data memory (8).

9. The display device (1) according to claim 1,
wherein the at least one detection device (5) and the layer (4) are further configured to detect gestures during actuation, and
wherein the computing device (6) is further configured to check whether the gestures detected by the layer (4) and the at least one detection device (5) correspond to each other and correspond to gestures stored in a data memory (8).

10. The display device (1) according to one of claim 1,
wherein the display means (2) comprises two or more display parts (2a, 2b),
wherein each display part (2a, 2b) is configured to display a part of each button (3),
wherein the display parts (2a, 2b) are arranged one above the other, at least one display part (2a) is semi-transparent and the buttons (3) result from the superimposition of the partial displays, and
wherein the partial displays can be made deferred in place and time.

11. The display device (1) according to claim 1,
wherein the display means (2) comprises two or more display parts (2a, 2b),
wherein each display part (2a, 2b) is configured to display a part of each button (3),
wherein the display parts (2a, 2b) are arranged next to each other and each button (3) extends to each display part (2a, 2b).

12. The display device (1) according to one of claim 1, wherein the display means (2) is configured to display buttons (3) such that the buttons (3) or their surrounding surfaces have one or more of the following features:
changing the display position after a predetermined time,
showing a continuous movement over the display means (2), visible flashing,
flashing in such a way that the flashing is not visible but can be detected by the detection device (5),
showing a dynamic change in brightness and/or color, and/or
showing patterns in a dynamic change of brightness and/or color.

13. The display device (1) according to claim 1, wherein the computing unit (6) is further configured to perform the checking for two or more buttons (3) simultaneously.

14. The display device (1) according to claim 1, wherein the computing unit (6) is configured to take into account an actuation of a button (3) detected by the at least one detection device (5) only when a predefined period of time has elapsed between the start of the display of the button (3) and its actuation.

15. The display device (1) according to claim 14, wherein the display means (2) displays the buttons (3) differently during the predefined period of time than after the predefined period of time has elapsed.

16. A method (100) for displaying on a display device (1) for a control system of potentially hazardous technical systems, such as industrial plants, machines or motor vehicles, the method comprising:
displaying (110) at least one or more buttons (3) by a display means (2),
detecting (120) actuations of the display device (1) and their positions by a transparent and touch-sensitive layer (4) arranged on the display means (2),
detecting (130) the buttons (3) of the display means (2) and actuations of the display device (1) and their positions by at least one detection device (5), and
checking (140), by a computing device (6),
whether the buttons (3) of the display means (2) detected by the at least one detection device (5) correspond to the buttons (3) to be displayed by the display means (2), and
whether the actuations and/or positions detected by the layer (4) and the at least one detection device (5) correspond to each other and to the displayed buttons (3), and
sending (150), by the computing device (6), information or control signals depending on the result of checking (140), and
triggering a potentially dangerous function assigned to the button (3) by the control system only if the display of the button (3) detected by the detection device (5) actually corresponds to the function assigned by the control system to the button (3), so that a safe process is carried out in a machine or device to be operated by actuation of the display device (1).

17-18. (canceled)

19. The method (100) for displaying according to claim 16, wherein detecting (130) the buttons comprises detecting (132) fingerprints by a detection device (5) which is a fingerprint sensor (7).

20. The method (100) for displaying according to claim 19, wherein checking (140) comprises checking (141) whether the detected fingerprints correspond to fingerprints stored in a data memory (8).

21. The method (100) for displaying according to claim 16,
wherein detecting (120) actuations and detecting (130) the buttons comprises detecting (121, 131) gestures during the actuation, and
wherein checking (140) comprises checking (141) whether the gestures detected by the layer (4) and the at least one detection device (5) correspond to each other and correspond to gestures stored in a data memory (8).

22. The method (100) for displaying according to claim 16,
wherein displaying (110) is effected by two or more display parts (2a, 2b) of the display means (2), wherein each display part (2a, 2b) displays a part of each button (3) in such a way that the buttons (3) result from the superimposition of the partial displays, wherein the partial displays can be made deferred in place and time.

23. The method (100) for displaying according to claim 16,
wherein displaying (110) is effected by two or more display parts (2a, 2b) of the display means (2), wherein each display part (2a, 2b) displays a part of each button (3) in such a way that each button (3) extends to each display part.

24. The method (100) for displaying according to claim 16, wherein displaying (110) the buttons (3) is performed such that the buttons (3) or their surrounding surfaces have one or more of the following features:
changing the display position after a predetermined time,
showing a continuous movement over the display means (2),
visible flashing,
flashing in such a way that the flashing is not visible but can be detected by the detection device (5),
showing a dynamic change in brightness and/or color, and/or
showing patterns in a dynamic change of brightness and/or color.

25. The method (100) for displaying according to claim 16, wherein checking (140) checks two or more buttons (3) simultaneously.

26. The method (100) for displaying according to claim 16, wherein checking (140) takes into account an actuation of a button (3) only when a predefined period of time has elapsed between the start of the display of the button (3) and its actuation.

27. The method (100) for displaying according to claim 26, wherein displaying (110) displays the buttons (3) differently during the predefined time period than after the predefined time period has elapsed.

28. A non-transitory computer program product which is directly loadable into a memory of a programmable control apparatus of a display device (1), with program code means for executing all steps of the method according to claim 16 when the program product is executed on the control apparatus.

29. The display device (1) according to claim 1, wherein one of the at least one detection device (5) is a camera.
